(19) United States
(12) Patent Application Publication
(10) Pub. No.: US 2004/0100733 A1
(43) Pub. Date: May 27, 2004

(54) Disk drive inertial latch

(75) Inventors: Long V. Nguyen, San Jose, CA (US); Trao B. Ly, Mountain View, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA

(21) Appl. No.: 10/687,048

(22) Filed: Oct. 16, 2003

Related U.S. Application Data
(60) Provisional application No. 60/429,757, filed on Nov. 27, 2002.

(51) Int. Cl. G11B 5/54

(52) U.S. Cl. 360/256.4

(57) ABSTRACT

One embodiment of the present invention is an inertial latch for an actuator of a disk drive that includes: an inertial lever, which inertial lever includes: (a) a first and a second pivot structure that are disposed to enable the inertial lever to rotate about a first or a second center of rotation; (b) a first and a second magnetically attractive member that are disposed to enable the inertial lever to move to a predetermined position in the absence of a rotational shock; and (c) a latch disposed to latch an actuator lock mechanism of the actuator.

This application claims the benefit of U.S. Provisional Application No. 60/429,757, filed on Nov. 27, 2002, which is incorporated herein by reference.

### TECHNICAL FIELD OF THE INVENTION

One or more embodiments of the present invention relate generally to method and apparatus for latching an actuator in a disk drive.

### BACKGROUND OF THE INVENTION

With a growing market in mobile devices that require high capacity memory storage such as, for example and without limitation, a disk drive, many disk drive developers have been scrambling to develop a robust hard disk drive (“HDD”) that can withstand large shocks. There are generally two types of shocks, i.e., translational shocks and rotational shocks. Of the two types of shock, translational shocks are of less concern to a designer since a disk drive actuator can be designed so it is balanced and will not move in response to a translational shock. However, it is difficult, if not impossible, to design the disk drive actuator so it will not move in response to a rotational shock.

In accordance with prior art methods, disk drive developers utilize an “inertial latch” to mitigate the effects of rotational shock. A typical inertial latch that is fabricated in accordance with prior art methods includes an inertial mass rotating about a fixed pin, and a mechanism to maintain the inertial mass in a so-called “neutral” position. This mechanism can be a magnet, a spring, or another latch component that utilizes a voice coil magnet (“VCM”) of a disk drive to provide a “neutralizing” force. Such inertial latches are problematic because they are costly in terms of part count and assembly complexity.

In light of the above, there is a need to overcome one or more of the above-identified problems.

### SUMMARY OF THE INVENTION

One or more embodiments of the present invention satisfy one or more of the above-identified needs in the art. In particular, one embodiment of the present invention is an inertial latch for an actuator of a disk drive that comprises: an inertial lever, which inertial lever includes: (a) a first and a second pivot structure that are disposed to enable the inertial lever to rotate about a first or a second center of rotation; (b) a first and a second magnetically attractive member that are disposed to enable the inertial lever to move to a predetermined position in the absence of a rotational shock; and (c) a latch disposed to latch an actuator lock mechanism of the actuator.

### BRIEF DESCRIPTION OF THE DRAWING

FIG. 1 shows, in pictorial form, a schematic diagram of a disk drive that includes an inertial latch in a “neutral position,” which inertial latch is fabricated in accordance with one or more embodiments of the present invention;

FIG. 2 shows a perspective view of the disk drive shown in FIG. 1 wherein a disk actuator has been removed to provide a view the inertial latch;

FIG. 3 shows a perspective view of a bottom of an actuator of a disk drive that is fabricated in accordance with one or more embodiments of the present invention with an overmolded coil that includes a cam feature and a channel;

FIG. 4 shows a perspective view of the disk drive shown in FIG. 1 wherein a latch pin can be seen using a channel in the overmolded coil;

FIGS. 5 and 6 show, in pictorial form, a schematic of the disk drive that includes an inertial latch that is fabricated in accordance with one or more embodiments of the present invention, which inertial latch is latched in response to a clockwise and a counterclockwise rotational shock, respectively; and

FIG. 7 shows a perspective view of a load/unload ramp of the disk drive.

### DETAILED DESCRIPTION

An inertial latch that is fabricated in accordance with one or more embodiments of the present invention, latches an actuator in a disk drive to an actuator lock mechanism whenever the disk drive is in a non-operating condition and is subjected to an external rotational shock, and holds the actuator at a predetermined position (depending on the direction of the rotational shock).

In particular, one or more embodiments of the present invention relate to an inertial latch for an actuator of a disk drive such as, for example and without limitation, a small form factor disk drive. Such an inertial latch includes a latch and an inertial lever including pivot structures that enable the inertial lever to rotate about a first or a second center of rotation. In a disk drive, the first center of rotation and the second center of rotation are provided by mechanisms external to the inertial latch, where rotation about the first or the second center of rotation depends on a direction of a rotational shock applied to the disk drive. In addition, the inertial latch “floats” in the disk drive. For example and without limitation, in accordance with one or more embodiments of the present invention, the inertial latch is constrained to move within an area defined by two (2) walls and two (2) locating mechanism, for example and without limitation, pins. In addition, in accordance with one or more embodiments of the present invention, a neutral position of the inertial latch is defined by a position of a disk drive magnet, for example and without limitation, a so-called VCM magnet, and a force of attraction between the magnet and two (2) magnetically attractive members (for example and without limitation, steel balls) carried by the latch. Advantageously, in accordance with one or more embodiments of the present invention, because the inertial latch “floats,” assembly is simplified since precision alignment mechanisms are not needed.

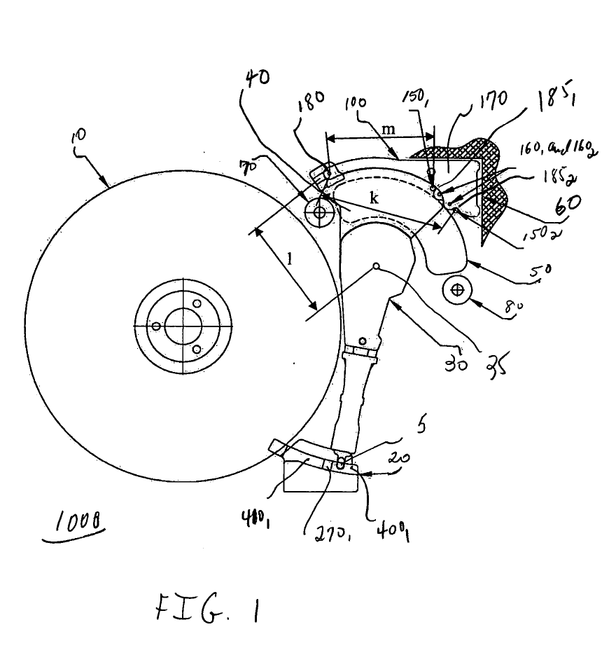

FIG. 1 shows disk drive 1000 that includes inertial latch 100 in a “neutral position” (i.e., in the absence of rotational shock), which inertial latch 100 is fabricated in accordance with one or more embodiments of the present invention. As shown in FIG. 1, disk drive 1000 includes disk 10, load/unload ramp 20, actuator 30 that includes overmolded coil 40 (actuator 30 rotates about fixed pivot 35), VCM magnet 50, disk drive constraint walls 60, outside disk crashstop 70, and inner disk drive crashstop 80. The functionality of, and methods of fabricating, disk 10, load/unload ramp 20, actuator 30, VCM magnet 50, disk drive constraint walls 60, outside disk crashstop 70, and inner disk drive crashstop 80 are well known to those of ordinary skill in the art. As further shown in FIG. 1, disk drive 1000 further includes locating mechanisms in the form of locating pins 150₁ and 150₂. In addition, in accordance with one or more embodiments of the present invention, locating pins 150₁ and 150₂, VCM magnet 50, and constraint walls 60 are fixed in a baseplate (not shown) of disk drive 1000. As will be described in detail below, in accordance with one or more embodiments of the present invention, inertia latch 100 operates to lock actuator 30 in: (a) a first position whenever disk drive 1000 is subjected to a counterclockwise rotational shock (i.e., to prevent actuator 30 from rotating clockwise and landing on disk 10); and (b) a second position whenever disk drive 1000 is subjected to a clockwise rotational shock.

As shown in FIG. 1, inertial latch 100 comprises magnetically attractive members 160₁ and 160₂ (such as, for example and without limitation, steel balls), inertial lever 170 (fabricated, for example and without limitation, from a relative heavy metal mass), and a latch in the form of, for example and without limitation, latch pin 180 that extends upward and either rides in a downwards facing channel in overmolded coil 40 or latches an actuator lock mechanism in the form of, for example and without limitation, cam features on overmolded coil 40 in a manner that will be described in detail below. Inertial latch 100 further comprises pivot structures 185₁ and 185₂ (for example and without limitation, pockets) which, as will be described in detail below, are disposed against either or both of locating pins 150₁ and 150₂ to enable inertial latch 100 to be disposed in a predetermined position or to rotate about locating pin 150₁ or locating pin 150₂ (whereby locating pins 150₁ and 150₂ provide a first or a second center of rotation for inertial latch 100, respectively). The mass of inertial lever 170 should be large enough to overcome magnetic and frictional forces encountered when a counterclockwise rotational shock is experienced. As such, an appropriate mass for inertial lever 170 may be determined routinely by one of ordinary skill in the art without undue experimentation.

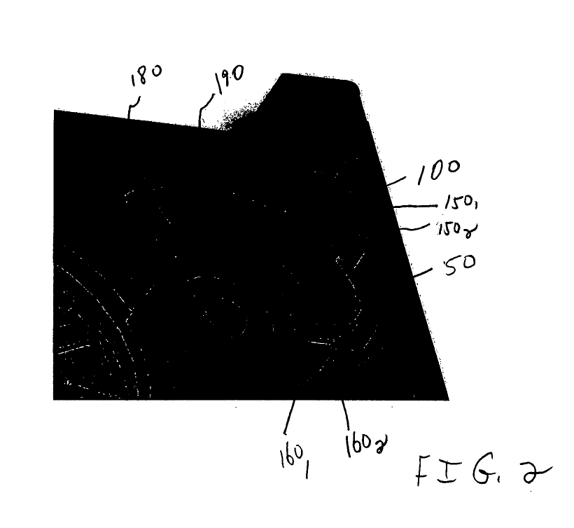

As further shown in FIG. 1, in the “neutral position,” inertial latch 100 is biased against locating pins 150₁ and 150₂ (and thereby, VCM magnet 50) by a magnetic force of attraction between VCM magnet 50 and magnetically attractive members 160₁ and 160₂. As a result, the “neutral position” of latch pin 180 relative to actuator 30 is determined by the positions of VCM magnet 50 and locating pins 150₁ and 150₂ which are disposed against pivot structures 185₁ and 185₂, respectively. FIG. 2 shows a perspective view of disk drive 1000 wherein actuator 30 has been removed to provide a view of inertial latch 100. FIG. 2 shows the relative positions of VCM magnet 50, locating pins 150₁ and 150₂, steel balls 160₁ and 160₂, and latch pin 180. Section 190 of inertial latch 100 is shown to have a reduced thickness to enable overmolded coil 40 to rotate thereover.

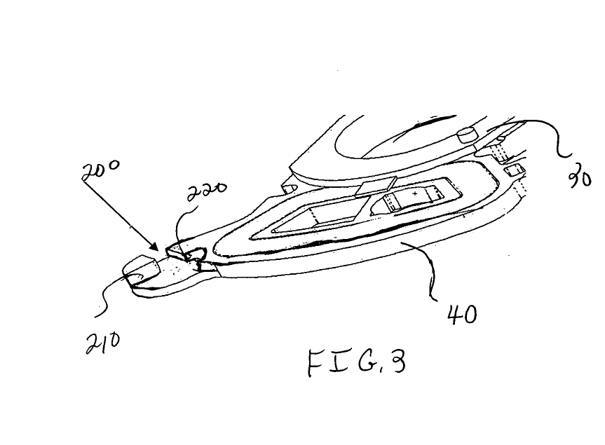

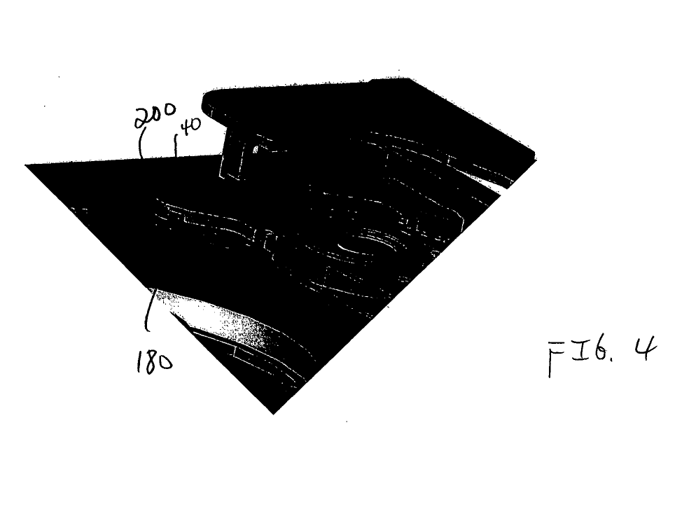

FIG. 3 shows a perspective view actuator 30 that is fabricated in accordance with one or more embodiments of the present invention, which actuator 110 includes overmolded coil 40 that includes channel 200 and an actuator lock mechanism in the form of cam features 210 and 220. Although cam features 210 and 220 are shown to be a portion of overmolded coil 40, further embodiments may be fabricated wherein cam features 210 and 220 are separate components which are affixed to actuator 30 or overmolded coil 40, or cam features 210 and 220 may be integral parts actuator 30 or overmolded coil 40. Under normal operating conditions, i.e., reading/writing data from/to disk 10, latch pin 180 clears overmolded coil 40 by use of channel 200. This enables actuator 30 to move disk drive heads 5 onto disk 10 and access data under a controlled command from firmware. FIG. 4 shows a perspective view of disk drive 1000 wherein latch pin 180 can be seen using channel 200 in overmolded coil 40. However, whenever disk drive 1000 is in a non-operating condition, i.e., parked on load/unload ramp 20, and it is exposed to a rotational shock, latch pin 180 latches to cam feature 210 or 220 depending on whether the shock is clockwise or counterclockwise. For example, in accordance with one or more embodiments of the present invention, latch pin 180 latches cam feature 210 when disk drive 1000 is exposed to a clockwise rotational shock, and latch pin 180 latches cam feature 220 when disk drive 1000 is exposed to a counterclockwise rotational shock.

As one can readily appreciate from FIG. 1, for inertial latch 100 to function properly, distance k and m must be equal to or greater than distance l where: (a) distance k is the distance between latch pin 180 and locating pin 150₂; (b) distance m is the distance between latch pin 180 and locating pin 150₁; and (c) distance l is the distance between latch pin 180 and fixed pivot 35 of actuator 30.

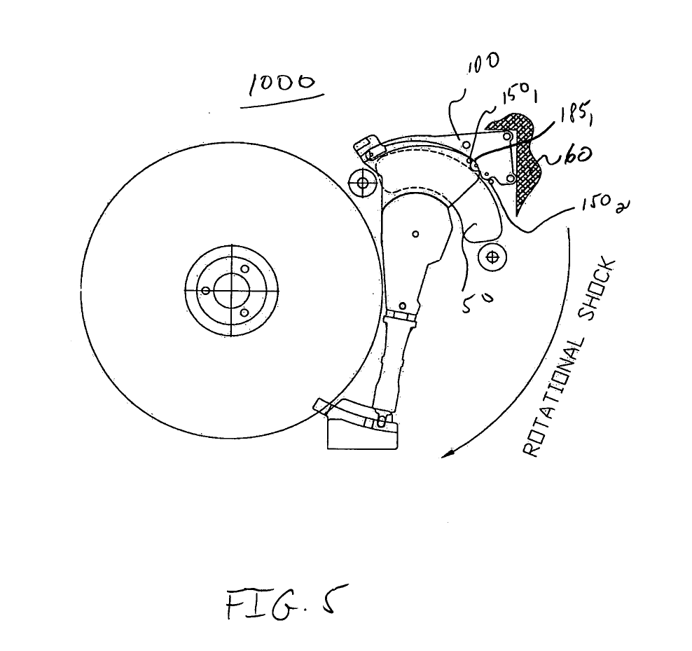

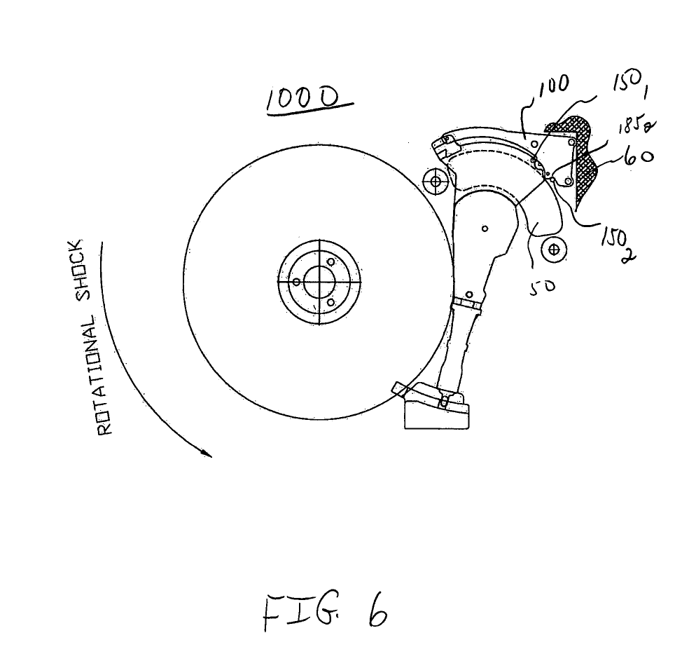

FIGS. 5 and 6 show disk drive 1000 after inertial latch 100 is latched in response to a clockwise and a counterclockwise rotational shock, respectively. As shown in FIGS. 5 and 6, inertial latch 100 floats within bounds provided by constraint walls 60 and locating pins 150₁ and 150₂. In addition, as can further be appreciated from FIGS. 5 and 6, locating pins 150₁ and 150₂ serve two functions: (a) locating inertial latch 100; and (b) providing centers of rotation for inertial latch 100 (i.e., depending on the direction of the rotational shock, either of locating pins 150₁ and 150₂ becomes a center of rotation). As shown in FIG. 5, inertial latch 100 rotates about locating pin 150₁ which is disposed against pivot structure 185₁; and as shown in FIG. 6, inertial latch 100 rotates about locating pin 150₂ which is disposed against pivot structure 185₂. In addition, when the rotational shock has been removed, a force of attraction between VCM magnet 50 and magnetically attractive members 160₁ and 160₂ returns inertial latch 100 to the “neutral position.”

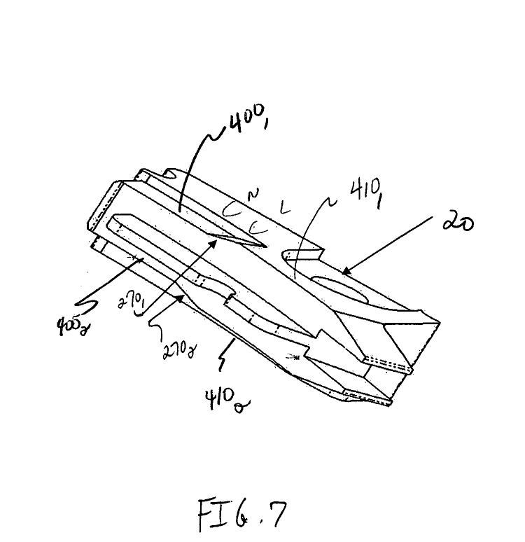

The following discusses how actuator 30 and inertial latch 100 are positioned in a non-operating condition (i.e., when disk drive heads 5 are parked on load/unload ramp 20). As shown in FIG. 1, OD crashstop 70 provides a first bound for the position of actuator 30, and detent feature 270 of load/unload ramp 20 provides a second bound for the position of actuator 30. FIG. 7 shows a perspective view of load/unload ramp 20. As shown in FIG. 7, load/unload ramp 20 includes regions 400₁ and 400₂, detent features 270₁ and 270₂, and elevated regions 410₁ and 410₂ (where elevated region 410₁, detent feature 270₁ and region 400₁ are also identified in FIG. 1). In a non-operating condition, for the neutral position (i.e., not latched), a load tab of actuator 30 (the load tab holds disk drive heads 5) should be positioned so that disk drive heads 5 are disposed in regions 400₁ and 400₂, (i.e., behind detent features 270₁ and 270₂ of load/unload ramp 20). At such a position, detente features 270₁ and 270₂ provide the second bound to movement of actuator 30. Such a positioning is shown in FIG. 1. Next, in a non-operating condition, in a latched position, the load tab should be positioned so that disk drive heads 5 are disposed in regions 400₁ and 400₂ or on detente features 270₁ and 270₂. At such a position, détente features 270₁ and 270₂ provide the second bound to movement of actuator 30. For example, if the load tab is positioned so that disk drive heads 5 are disposed on detente features 270₁ and 270₂, the slopes thereof provide a restorative force that urge disk drive heads 5 back to regions 400₁ and 400₂ whenever inertial latch 100 unlatched (i.e., as described above, when the rotational shock is gone, and inertial latch is rotated back to its neutral position).

In addition, referring to FIG. 3, actuator 30 and inertial latch 100 are positioned in a non-operating condition so that, under rotational shock, latch pin 180 will engage one or the other of cam features 210 and 220. For example, if latch pin 180 is disposed inside channel 200 or far beyond channel 200 when actuator 30 and inertial latch 100 are positioned in a non-operating condition, then latch pin 180 would not engage either of cam features 210 and 220. If this were the case, no latching would occur.

Although various embodiments that incorporate the teachings of the present invention have been shown and described in detail herein, those skilled in the art can readily devise many other varied embodiments that still incorporate these teachings.

What is claimed is:

1. An inertial latch for an actuator of a disk drive that comprises:
an inertial lever, which inertial lever includes:
a first and a second pivot structure that are disposed to enable the inertial lever to rotate about a first or a second center of rotation;
a first and a second magnetically attractive member that are disposed to enable the inertial lever to move to a predetermined position in the absence of a rotational shock; and
a latch disposed to latch an actuator lock mechanism of the actuator.

2. The inertial latch of claim 1 wherein rotation about the first or the second center of rotation depends on a direction of a rotational shock applied to the disk drive.

3. A disk drive that includes an inertial latch, which disk drive comprises:
an actuator that includes an actuator lock mechanism;
a magnet;
a first and a second locating mechanism disposed at predetermined locations with respect to the magnet;
walls;
an inertial latch that floats within an area constrained by positions of the walls and the first and second locating mechanisms, wherein the inertial latch includes an inertial lever, which inertial lever includes:
a first and a second pivot structure that are disposed to enable the inertial lever to rotate about a first or a second center of rotation, which first and second center of rotation are provided by the first and second locating mechanisms;
a first and a second magnetically attractive member that are disposed to cause the first and second pivot structures to abut the first and second locating mechanisms in the absence of a rotational shock; and
a latch disposed to latch an actuator lock mechanism of the actuator.

4. The disk drive of claim 3 wherein the latch includes a pin and the actuator lock mechanism includes a first and a second cam features separated by a channel.

5. The disk drive of claim 4 wherein the pin is positioned to travel within the channel in the absence of a rotational shock.

6. The disk drive of claim 5 wherein the pin is positioned to engage the first cam feature in the presence of a clockwise rotational shock and to engage the second cam feature in the presence of a counterclockwise rotational shock.

7. The disk drive of claim 3 wherein the inertial latch rotates about the first center of rotation in the presence of a clockwise rotational shock and about the second center of rotation in the presence of a counterclockwise rotational shock.

8. The disk drive of claim 3 wherein the first and the second magnetically attractive members are steel members.
